(19) United States
(12) Patent Application Publication
(10) Pub. No.: US 2024/0094605 A1
(43) Pub. Date: Mar. 21, 2024

(54) Night Shade

(71) Applicant: John Edward Afful, Murrieta, CA (US)

(72) Inventor: John Edward Afful, Murrieta, CA (US)

(21) Appl. No.: 17/803,647

(22) Filed: Sep. 19, 2022

(51) Int. Cl. G03B 11/04; G06F 1/16; G06F 3/039

(52) U.S. Cl. CPC G03B 11/041; G06F 1/1607; G06F 3/0395

(57) ABSTRACT

A mousepad designed to enable privacy when the user of a laptop computer, tablet computer, desk top computer, or cellphone does not want to be seen. The mouse pad acts as a regular mouse pad whereas the detachable clip is securely fastened on whatever device is being used with the intent of covering the camera. The markings on the detachable clip clearly display a microphone and question mark which are used as a reminder to mute the microphone on the laptop computer, tablet computer, desk top computer, or cellphone.

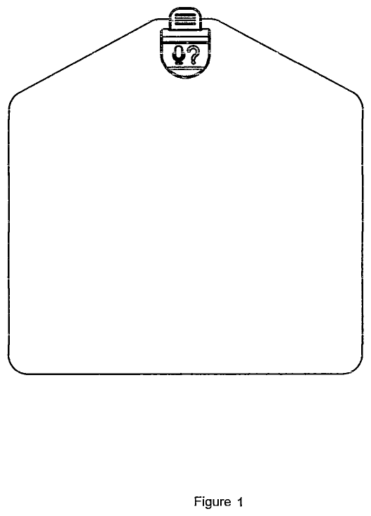

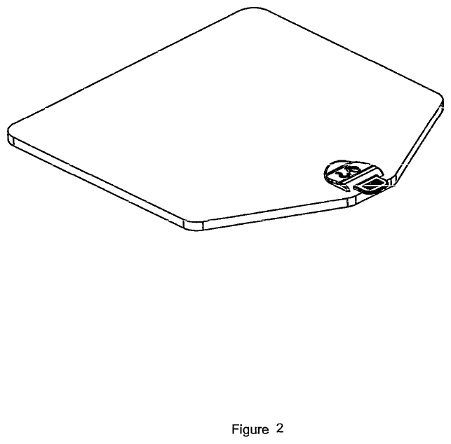

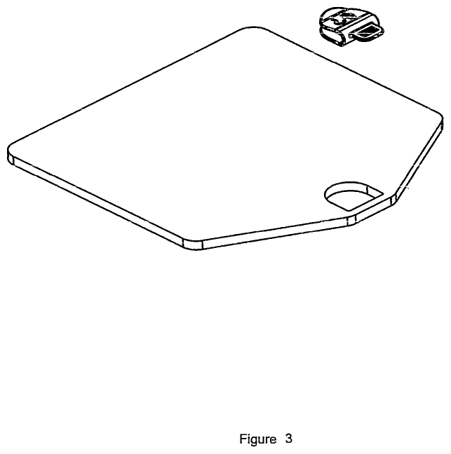

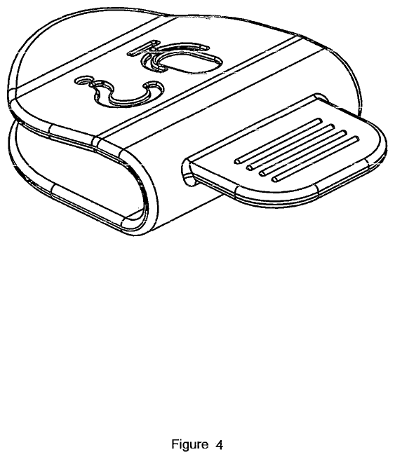

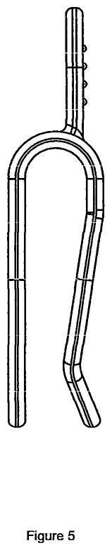

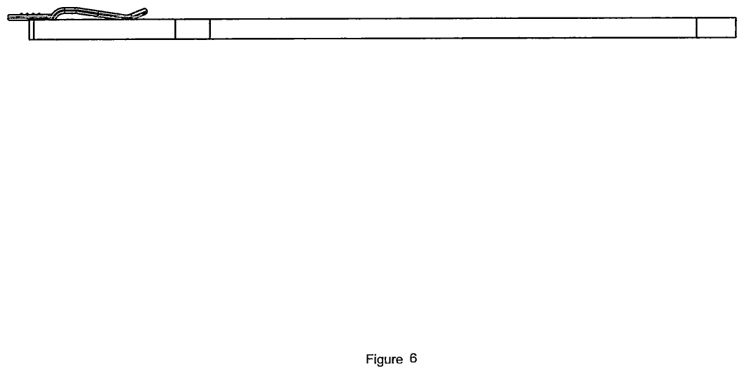

The Night Shade has two essential functions:
1. To cover the lens of a laptop computer, tablet computer, desk top computer, or cellphone to ensure that the users of these items are not visible at the time when The Night Shade is in use.
2. To serve as a reminder to the user to mute the volume of the laptop computer, tablet computer, desk top computer, or cellphone if and when The Night Shade is in use.

### BRIEF DESCRIPTION OF DRAWINGS

Figure Label #1 is a picture of The Night Shade in its entirety from above.

Figure Label #2 is a picture of The Night Shade in its entirety from an angle.

Figure Label #3 is a picture of The Night Shade from an angle with the clip that covers the lens detached and set off to the side.

Figure Label #4 is a picture of the clip by itself at an angle.

Figure #5 is a picture of the clip standing up from a side view.

Figure #6 is a picture of The Night Shade in its entirety laying on its back flat from a side view.

What is claimed is:

1. A fastening system for a web cam comprising: a detachable clip that covers the web cam of a laptop computer, tablet computer, desk top computer, or cellphone.

2. A reminder to mute the microphone on the laptop computer, tablet computer, desk top computer, or cellphone when the clip is in use consisting of etchings on the actual clip that shows a microphone and question mark.

3. A mouse pad that consists of a cutout in the shape of the clip that securely houses the clip when it is not in use to cover the web cam on a laptop computer, tablet computer, desk top computer, or cellphone.
